(19) United States
(12) Patent Application Publication
(10) Pub. No.: US 2024/0025313 A1
(43) Pub. Date: Jan. 25, 2024

(54) Storage Area

(71) Applicant: APPLE INC., Cupertino, CA (US)

(72) Inventors: Philipp J. Wolf, Capistrano Beach, CA (US); James J. Dowle, Laguna Beach, CA (US); Per G. Isaksson, Gothenburg (SE)

(21) Appl. No.: 18/375,659

(22) Filed: Oct. 2, 2023

Related U.S. Application Data
(63) Continuation of application No. PCT/US2022/021973, filed on Mar. 25, 2022.
(60) Provisional application No. 63/170,131, filed on Apr. 2, 2021.

(51) Int. Cl. B60N 2/30

(52) U.S. Cl. CPC B60N 2/3047; B60N 2/3015; B60N 2/3065

(57) ABSTRACT

A body defines a compartment. A bottom and a back are positioned in the compartment and reconfigurable between a first configuration and a second configuration. The bottom defines a storage area therebelow. The bottom and the back are coupled to and supported by the body. In the first configuration relative to the second configuration, the bottom is positioned toward a central portion of the compartment and the back is pivoted away from the central portion. The storage area is accessible from the central portion of the compartment.

### CROSS-REFERENCE TO RELATED APPLICATION(S)

This application is a continuation of International Application No. PCT/US2022/021973, filed on Mar. 25, 2022, which claims the benefit of U.S. Provisional Patent Application No. 63/170,131, filed on Apr. 2, 2021, the content of which is hereby incorporated by reference in its entirety for all purposes.

### TECHNICAL FIELD

This disclosure relates to storage areas.

### BACKGROUND

A bottom and back may be adjustable to provide comfort and/or to change a position, for example, being adjustable in a fore-aft position, height, bottom angle, and/or back angle. However, greater adjustability requires greater amounts of space, both to account for movement and increased size. As a result, the space may not be available for other purposes.

### SUMMARY

Disclosed herein are implementations of seats and passenger vehicles having seats.

In one implementation, a body includes a lower side, a left side, a right side, a front side, and a rear side that are coupled to each other to cooperatively define a compartment. A bottom and a back are positioned in the compartment and reconfigurable between a first configuration and a second configuration. The bottom defines a storage area therebelow. The bottom and the back are coupled to and supported by the body independent of the lower side. In the first configuration relative to the second configuration, the bottom is positioned toward a central portion of the compartment and the back is pivoted away from the central portion. The storage area is accessible from the central portion of the compartment.

In one implementation, a passenger vehicle includes a vehicle body and a seat. The vehicle body includes a floor, a left side, a right side, a front side, and a rear side that are structures coupled to each other to cooperatively define a passenger compartment. The seat includes a seat bottom and a seat back that are reconfigurable between an upright configuration and a reclined configuration. The seat is positioned in the passenger compartment with the seat bottom spaced above the floor to define an underseat volume therebetween. The seat is coupled to and supported by the vehicle body independent of the floor. In the reclined configuration relative to the upright configuration, the seat bottom is positioned toward a central portion of the passenger compartment and the seat back is pivoted away from the central portion. The underseat volume is accessible from the central portion of the passenger compartment.

In one implementation, a seat for a passenger vehicle includes a seat bottom, a seat back, a bottom pivot, and a movement and support system. The seat bottom is moveable between a first bottom configuration and a second bottom configuration in which the seat bottom is positioned forward relative to the first bottom configuration. The seat back is moveable between a first back position and a second back position in which the seat back is titled rearward relative to the first back position. The bottom pivot provides a pivot by which the seat back is pivotable relative to the seat bottom. The movement and support system is configured to couple the seat to an upright structure of the passenger vehicle to be supported thereby, to selectively move the seat bottom between the first bottom configuration and the second bottom configuration, and to move the seat back between the first back position and the second back position.

In one implementation, a seat for a passenger vehicle includes a seat bottom, a seat back, a bottom pivot, an upper pivot, an angle mechanism, and a displacement mechanism. The bottom pivot is a pivot by which the seat back is pivotably coupled to the seat bottom. The upper pivot is a pivot by which the seat back is pivotably couplable to an upright structure of a vehicle body; the upper pivot is at a fixed position on the seat back. The angle mechanism selectively transfers force between the seat bottom and the seat back to selectively maintain the seat back in each of a first back position and a second back position having a greater angle between the seat back and the seat bottom than in the first back position. The displacement mechanism includes a linkage and a linear actuator. The linkage is a rigid elongated structure pivotably coupled at a first end thereof to the seat bottom and at a second end thereof to the linear actuator. The linear actuator is configured to couple to the upright structure of the vehicle body and selectively move the second end of the linkage along the upright structure to selectively maintain the seat bottom in each of a first bottom position and a second bottom position in which the seat bottom is further from the upright structure than in the first bottom position.

In one implementation, a seat for a passenger vehicle includes a seat bottom, a seat back, a displacement mechanism, and an angle mechanism. The seat back is pivotably coupled to the seat bottom at a bottom pivot. The displacement mechanism includes a track and a carriage. The track fixedly couplable to an upright structure of a vehicle body to support the seat bottom above a floor of the vehicle body. The carriage is fixedly coupled to the seat bottom and is selectively slidable along the track to selectively maintain the seat bottom in a first bottom position and a second bottom position in which the seat bottom is displaced further away from the upright structure than in the first bottom position. The angle mechanism includes an extendable linkage that extends between and is pivotably coupled to an upper pivot at a fixed position on the seat back and the carriage. The extendable linkage is selectively extendable to selectively maintain the seat bottom and the seat back in each of a first back position and a second back position having a greater angle between the seat back and the seat bottom than in the first back position.

In one implementation, a seat for a passenger vehicle includes a seat bottom, a seat back, a bottom pivot by which the seat back is pivotably coupled to the seat bottom, and an upper pivot by which the seat back is pivotably couplable to an upright structure of a vehicle body, the upper pivot being at a fixed position on the seat back. The seat also includes an angle mechanism that selectively transfers force between the seat bottom and the seat back to selectively maintain the seat back in each of a first back position and a second back position having a greater angle between the seat back and the seat bottom than in the first back position, and a displacement mechanism coupled to an upright structure of the vehicle and configured to selectively maintain the seat bottom in each of a first bottom position and a second bottom position in which the seat bottom is further from the upright structure than in the first bottom position.

### BRIEF DESCRIPTION OF THE DRAWINGS

FIG. 1 is a top view of a passenger vehicle.

FIG. 2 is a cross-sectional view of the passenger vehicle taken along line 2-2 in FIG. 1.

FIG. 3 is a partial cross-sectional view of the passenger vehicle taken along line 3-3 in FIG. 1 depicting a seat in a first configuration.

FIG. 4 is a partial cross-sectional view of the passenger vehicle taken along line 4-4 in FIG. 1 depicting the seat in a second configuration.

FIG. 5 is a schematic view of the passenger vehicle.

FIG. 6 is a schematic view of an example hardware configuration for a control system of the passenger vehicle.

FIG. 7 is a partial cross-sectional view of the passenger vehicle with the seat having a movement and support system of the seat depicted schematically.

FIG. 8 is a partial cross-sectional view of the passenger vehicle with the seat in the first configuration and having a first embodiment of the movement and support system.

FIG. 9 is a partial cross-sectional view of the passenger vehicle with the seat in the first configuration and having the first embodiment of the movement and support system.

FIG. 10 is a partial cross-sectional view of the passenger vehicle with the seat in the first configuration and having a second embodiment of the movement and support system.

FIG. 11 is a partial cross-sectional view of the passenger vehicle with the seat in the first configuration and having the second embodiment of the movement and support system.

### DETAILED DESCRIPTION

As discussed in further detail below, a vehicle may include one or more seats that are configured both to recline to provide user comfort, while also providing (e.g., preserving) space within a passenger compartment for passengers to place their belongings or other objects.

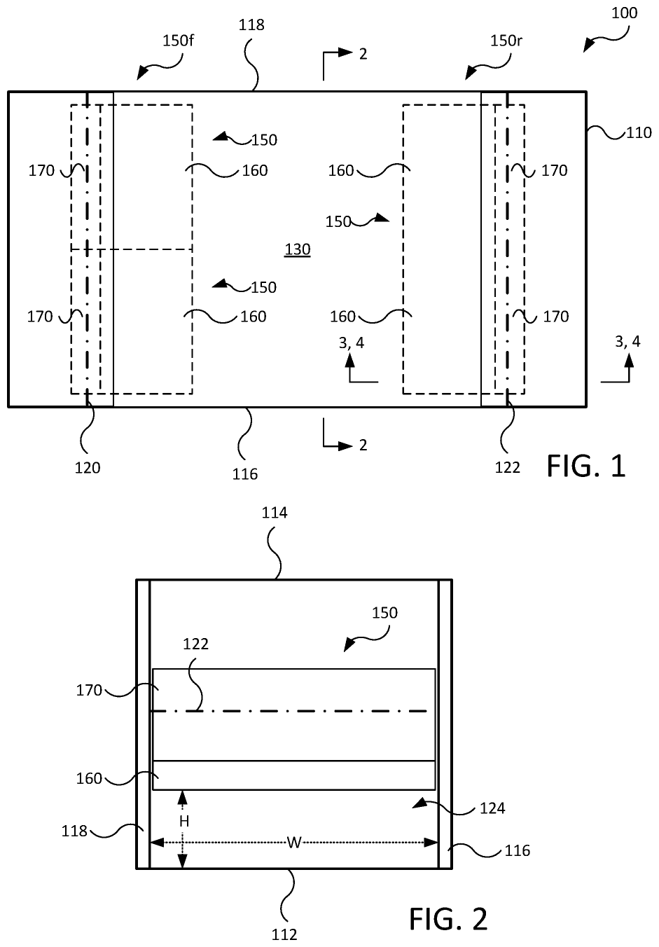

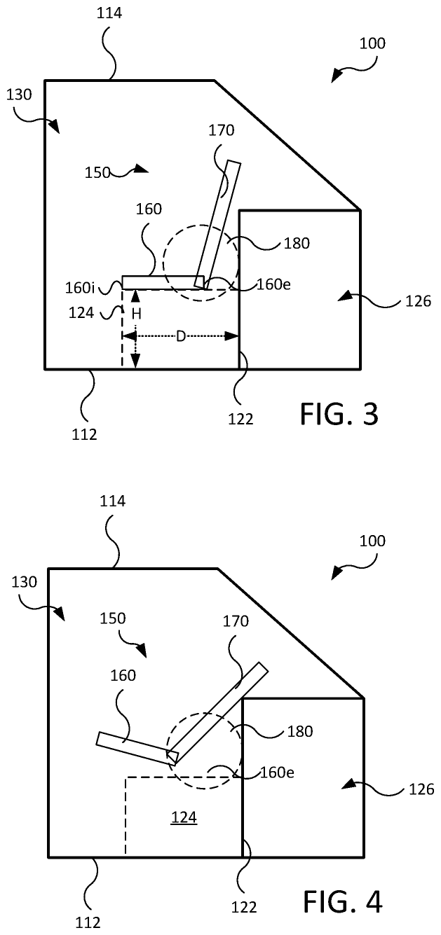

Referring to FIGS. 1-4, a vehicle 100 includes a vehicle body 110 that defines a passenger compartment 130 and one or more seats 150 disposed within the passenger compartment 130. The vehicle body 110 generally includes a floor 112, a roof 114, a left side 116, a right side 118, a front side 120, and a rear side 122, which are structures coupled to each other to define the passenger compartment 130 therebetween. The floor 112 and the roof 114 are spaced apart from each other in an upright direction. The left side 116 and the right side 118 are upright structures that are spaced apart from each other in an inboard-outboard direction, each extending upright from the floor 112 to the roof 114 and fore-aft from the front side 120 to the rear side 122. The left side 116 and the right side 118 may be structures that separate the passenger compartment 130 from an exterior environment of the vehicle 100. The front side 120 and the rear side 122 are upright structures and that spaced apart from each other in the fore-aft direction, each extending upright from the floor 112 toward the roof 114 and inboard-outboard from the left side 116 to the right side 118. The front side 120 and/or the rear side 122 may extend upward in regions adjacent the seats 150 only a portion of the height of the seats 150 (e.g., between the seat bottom 160 and a top of the seat back 170, as discussed in further detail below). The front side 120 and the rear side 122 may be structures that separate the passenger compartment 130 from the exterior environment of the vehicle 100 and may further separate the passenger compartment 130 from a vehicle systems compartment 126 that is outside the passenger compartment 130 and/or from other compartments of the vehicle 100, such as a storage compartment that is accessible from outside the passenger compartment 130 (e.g., a trunk or frunk) or vehicle system compartment or other region in which components of a drive system of the vehicle 100 are disposed (e.g., a motor, gearbox, battery, and/or controller, as discussed below). The vehicle body 110 may also be referred to as a body. The floor 112 and the roof 114 may also be referred to as lower and upper sides, respectively. The left side 116, the right side 118, the front side 120, and the rear side 122 may also be referred to as upright sides or structures. The various sides and/or structures of the vehicle body 110 may also be identified numerically (e.g., first, second, third, etc.) to distinguish from each other. The passenger compartment 130 may also be referred to as a compartment.

Each of the roof 114, the left side 116, the right side 118, the front side 120, and the rear side 122 may include covers (e.g., trim panels) that hide underlying structures from view and form interior surfaces of the passenger compartment 130. Each of the roof 114, the left side 116, the right side 118, the front side 120, and the rear side 122 may include windows (not labeled) for the passengers to view the physical environment of the vehicle 100 from the passenger compartment 130. The left side 116, and/or the right side 118 may further include openings (not shown) to allow ingress and egress of the passengers from the passenger compartment 130 and movable doors (not shown) that selectively open and close the openings.

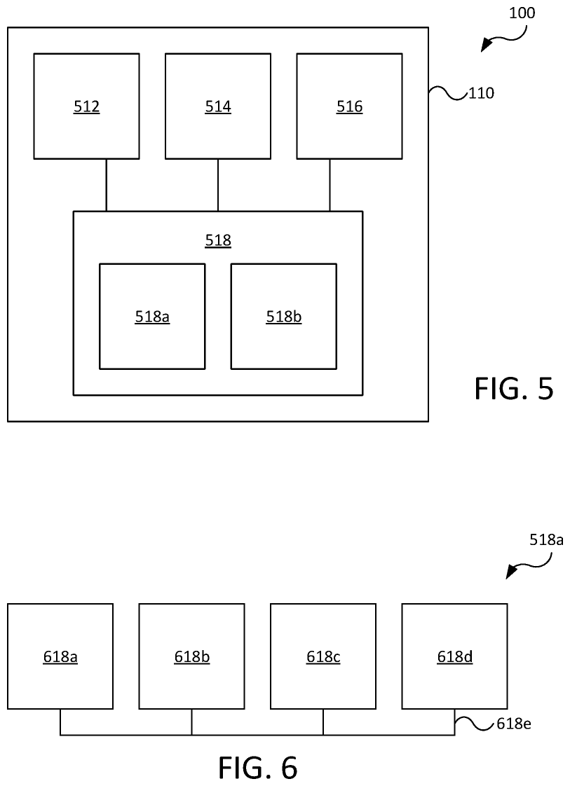

Referring to FIG. 5, the vehicle 100 may further include a drive system 512, a braking system 514, a steering system 516, and a control system 518, which are operatively coupled to the vehicle body 110 for traversing the environment of the vehicle 100 (e.g., along a roadway to a destination). The drive system 512, for example, includes a motor, a battery that stores electrical energy for operating the motor, and wheels that are rotated by the motor to propel the vehicle 100 along the roadway. As referenced above, components of the drive system, such as the motor, battery, and/or gearbox, may be stored in the vehicle systems compartment 126 or otherwise outside the passenger compartment 130 (e.g., so as to not be physically accessible by passengers during normal operation of the vehicle 100). The braking system 514 includes, for example, friction brakes (e.g., rotors and brake calipers) that slow rotation of the wheels. The steering system 516 includes, for example, a rack-and-pinion steering rack that is operated by a motor to pivot the wheels for steering the vehicle 100 (i.e., changing lateral direction) along the roadway. The control system 518 includes, for example, a controller 518a and sensors 518b for operating the drive system 512, the braking system 514, and the steering system 516 to traverse the physical environment. The sensors 518b sense various conditions of the physical environment (e.g., the location and/or conditions of the roadway, obstacles such as vehicles, pedestrians, and/or objects in the environment). The controller 518a operates the drive system 512, the braking system 514, and the steering system 516 according to the sensors 518b (e.g., the conditions sensed thereby) to traverse the environment and navigate obstacles therein. The vehicle 100 may be an autonomous vehicle by which the control system 518 operates the other systems of the vehicle 100 to traverse the environment substantially independent of direct control by a passenger (e.g., driver) of the vehicle 100. For example, the control system 518 may receive a destination input from the passenger and then control the drive system 512, the braking system 514, and the steering system 516 to traverse the physical environment to reach the destination. In the case of the vehicle 100 being an autonomous vehicle, the vehicle 100 may still include manual inputs (e.g., a throttle pedal, a brake pedal, and a steering wheel) by which a human driver may provide inputs to directly control one or more of the drive system 512, the braking system 514, and/or the steering system 516.

Referring to FIG. 6, an example hardware configuration of the controller 518a is illustrated. The controller 518a generally includes a processor 618a, a memory 618b, a storage 618c, a communications interface 618d, and a bus 618e by which the other components of the controller 518a are in communication with each other. The controller 518a may be any suitable type of computing device for operating the various systems of the vehicle 100 as described herein and may be considered to include various other controllers associated with the various devices of the vehicle 100. The processor 618a may be any suitable processing device, such as a central processing unit, capable of executing instructions (e.g., software code) according to various inputs. The memory 618b is a short term, volatile storage device, such as random access memory. The storage 618c is a long term, non-volatile storage device capable of storing instructions and other information to be executed and/or used by the processor 618a, such as a hard disk drive or a solid state drive. The communications interface 618d is capable of sending and receiving information from the controller 518a, such as instructions sent from the controller 518a and/or information received from the sensors 518b.

Referring again to FIGS. 1-4, the vehicle 100 includes the one or more seats 150, which are positioned in the passenger compartment 130 and configured to support passengers thereon. The one or more seats 150 may include one or more front seats 150f (e.g., two as shown) and one or more rear seats 150r (e.g., two as shown). The front seats 150f are arranged forward of the rear seats 150r relative to a forward (e.g., a predominant) direction of travel of the vehicle 100, while the rear seats 150r are arranged rearward of the front seats 150f. As shown, the front seats 150f may be rear-facing seats configured for passengers thereon to normally face the rearward direction, but may instead be forward-facing seats configured for passengers thereon to generally face the forward direction. The rear seats 150r are forward-facing seats.

Referring to one of the seats 150, the seat 150 generally includes a seat bottom 160, a seat back 170, and a movement and support system 180. The seat bottom 160 is configured to support a passenger seated thereon and may, for example, include a frame structure (e.g., a seat pan), a cushion over the frame structure (e.g., foam or other compressible material), and a cover over the foam and/or the frame (e.g., fabric, leather, or other flexible sheet material). The seat bottom 160 extends in the fore-aft direction between an interior side 160i thereof and an exterior side 160e thereof. The interior side 160i is that side of the seat 150 that is arranged toward (e.g., faces) a central portion of the passenger compartment 130, while the exterior side 160e is that side of the seat that 150 that is arranged away from (e.g., faces away) the central portion of the passenger compartment 130. For the seats 150 that are forward-facing (e.g., the rear seats 150r, as shown), the interior side 160i is positioned forward of the exterior side 160e thereof, while for the seats 150 that are rearward-facing (e.g., the front seats 150f, as shown), the interior side 160i is positioned rearward of the exterior side 160e.

The seat back 170 extends upward relative to the seat bottom 160 and is configured for the passenger to lean there against (e.g., leaning their back thereagainst). Similar to the seat bottom 160, the seat back 170 generally includes a frame structure, a cushion over the frame structure, and a cover over the foam and/or the frame structure. The seat back 170 is positioned at the exterior side 160e of the seat bottom 160.

The movement and support system 180 is configured for the seat 150 to recline. For example, the seat 150 is configured to reconfigure between a first configuration (e.g., an upright configuration) and a second configuration (e.g., a reclined configuration). In the second configuration, the seat back 170 is reclined relative to the first configuration (i.e., pivoted away from the seat bottom 160, such as away from the interior side 160i of the seat bottom 160). For example, the seat back 170 (e.g., the frame structure thereof) may be configured to pivot at least 10, 20, 30 degrees or more between the first configuration and the second configuration. The configuration of the seat back 170 in the first configuration may be referred to as a first or upright position (e.g., first or upright back position), while the configuration of the seat back 170 in the second configuration may be referred to as a second or reclined position (e.g., second or reclined back or seat back position).

Furthermore, in the second configuration, the seat bottom 160 may be positioned interiorly relative to the first configuration. For example, in the second configuration, the seat bottom 160 may be positioned interiorly (i.e., forward in the case of a forward-facing seat, or rearward in the case of a rearward facing seat) relative to the first configuration by 5, 10, or more centimeters. In some embodiments, in the second configuration, the seat bottom 160 may be positioned upward relative to the first configuration. The configuration of the seat bottom 160 in the first configuration may be referred to as a first or retracted position, while the configuration of the seat bottom 160 in the second configuration may be referred to as a second or extended position.

The seat bottom 160 is, in each of the first configuration and the second configuration, positioned above and spaced apart from the floor 112 to define and underseat volume 124 that may also be referred to as a storage area or space. The underseat volume 124 is accessible by the passengers from the interior side 160i of the seat 150, for example, to be used for placing or storing object. The underseat volume 124 may not be accessible from outside the passenger compartment 130, for example, not being accessible directly through the left side 116, the right side 118, the front side 120, or the rear side 122 (e.g., from the exterior environment of the vehicle 100 and/or without reaching or otherwise passing through the passenger compartment 130). For example, the underseat volume 124 may be accessible only from within the passenger compartment 130. As shown, the underseat volume 124 may be open to the passenger compartment 130 but may include a door or other stationary or movable partition physically separating the underseat volume 124 from the central portion of the passenger compartment 130 (i.e., from between the front seats 150f and the rear seats 150r).

The underseat volume 124 may be considered to have a height H, a width W, and/or a depth D. Over each of the height H, the width W, and/or depth D, the underseat volume 124 may be unobstructed by structures or components of the seat 150 and/or the vehicle body 110, such that passengers may place possessions and other objects thereunder (e.g., luggage, boxes, groceries, etc.).

The height H of the underseat volume 124 is the vertical and/or perpendicular distance from the floor 112, which may include a covering thereof (e.g., carpeting, as described above), to the seat bottom 160 or other structure of the seat 150 thereunder (e.g., a portion of the movement and support system 180, which is described in further detail below). The height H of the underseat volume 124 is unobstructed by other structures or components of the seat 150 and/or the vehicle body 110. The height H of the underseat volume 124 may vary at different locations. The height H of the underseat volume 124 may, for example, be a minimum of 5, 10, 15, 20 centimeters or other suitable height.

The width W of the underseat volume 124 is the horizontal distance in a cross-car direction (e.g., left to right) between the left side 116 and the right side 118 of the vehicle body 110, which may include any trim covering thereof (as referenced above). The width W of the underseat volume 124 is unobstructed by other structures or components of the seat 150 and/or the vehicle body 110. The width W of the underseat volume 124 may vary at different locations. The width W of the underseat volume 124 may, for example, be between 100 and 200 centimeters.

The depth D of the underseat volume 124 is the horizontal distance in a fore-aft direction (e.g., the forward direction) measured from the interior side 160i toward the exterior side 160e of the seat bottom 160. The depth D of the underseat volume 124 is unobstructed by other structures or components of the seat 150 and/or the vehicle body 110. The depth D of the underseat volume 124 may vary at different locations. The depth D of the underseat volume 124 may, for example, be 20, 30, 40, 50, 60 or more centimeters or outer suitable depth. The depth D of the underseat volume 124 may, instead or additionally, be defined relative to a depth of the seat bottom 160 measured horizontally between the interior side 160i and the exterior side 160e of the seat bottom 160. For example, the depth D of the underseat volume 124 may be 75%, 80%, 85%, 90% or more of a total depth of the seat bottom 160. The depth D of the underseat volume 124 may terminate at the front side 120 or the rear side 122 of the vehicle body 110.

In specific examples, the underseat volume 124 may include a rectilinear volume that is unobstructed by the seat 150 or the vehicle body 110 having a height H of at least 15 centimeters (e.g., at least 20 centimeters), a width W of at least 100 centimeters (e.g., at least 120 centimeters), and a depth D of at least 30 centimeters (e.g., at least 40 or 50 centimeters).

The underseat volume 124 may be defined under only one of the seats 150 that, for example, spans an entire width of the passenger compartment 130 between the left side 116 and the right side 118. Alternatively, the underseat volume 124 may be defined under multiple of the seats 150 (e.g., two or three seats positioned adjacent to each other across the width of the passenger compartment 130).

In order to provide the underseat volume 124 that is unobstructed, the one or more of the seats 150 are coupled to the vehicle body 110 and supported above the floor 112 independent of the floor 112. For example, to be supported above the floor 112 independent thereof, the seat 150 may be coupled to and supported by another portion of the vehicle body 110 (e.g., the left side 116, the right side 118, the front side 120, and/or the rear side 122), such that all force transferred from the seat 150 to the floor 112 is transferred thereto by the other portion of the vehicle body 110. For example, the seat 150 may be coupled to and supported by the rear side 122 above the floor 112, while all force (if any) that is transferred from the seat 150 to the floor 112 is transferred through the rear side 122. The vehicle 100 may not include any other structure besides those upright structures that define the passenger compartment that functions to transfer force from the seat 150 to the floor 112 without transferring force through such upright structures.

The one or more seats 150 may each be supported by one or more of the upright structures of the vehicle body 110 above the floor. For example, the seat 150 may be coupled to and supported by the vehicle body 110 with any suitable combination of the left side 116, the right side 118, the front side 120 and/or the rear side 122. For example, each one of the seats 150 may be coupled to and supported by the left side 116 only, the right side 118 only, the front side 120 only, the rear side 122 only, the left side 116 and either the front side 120 or the rear side 122, the right side 118 and either the front side 120 or the rear side 122, or the left side 116 and the right side 118 (e.g., extending across a width of the passenger compartment 130) with or without also being coupled to and/or supported by the front side 120 or the rear side 122.

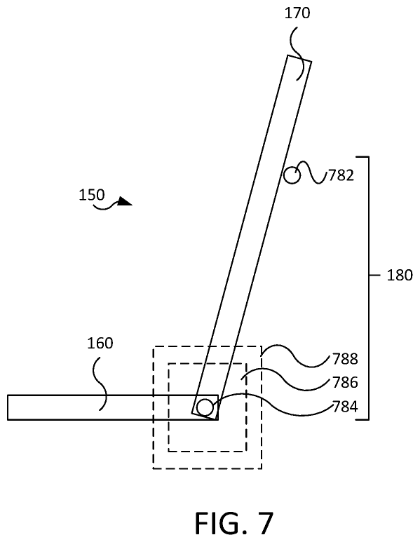

Referring to FIG. 7, the movement and support system 180 is configured to couple and support the seat 150 to the vehicle body 110 and to reconfigure the seat 150 between the first configuration and the second configuration by moving the seat bottom 160 and the seat back 170 relative to the vehicle body 110 and each other, while maintaining the underseat volume 124.

As shown schematically in FIG. 7, the movement and support system 180 generally includes an upper pivot 782, a lower pivot 784, an angle mechanism 786, and a displacement mechanism 788. The upper pivot 782 is located at a fixed position on the seat back 170 and is pivotably coupled to another structure or mechanism (e.g., the vehicle body 110 or of the movement and support system 180) and is configured for the seat back 170 to pivot relative thereto. The lower pivot 784 is located at fixed positions on each of the seat bottom 160 (e.g., at the exterior side 160e thereof) and the seat back 170 (e.g., the bottom end thereof) and is configured for the seat bottom 160 and the seat back 170 to pivot relative to each other. The angle mechanism 786 is coupled to one or both of the seat bottom 160 and/or the seat back 170 and is configured to control (e.g., change and selectively maintain) the angle between the seat bottom 160 and the seat back 170. The displacement mechanism 788 is coupled to one of the seat bottom 160 or the seat back 170 to control (e.g., change and selectively maintain) the position of the seat bottom 160 relative to the vehicle body 110. Selective operation may, for example be performed by the passengers or initiated by the passengers and performed by the control system 518.

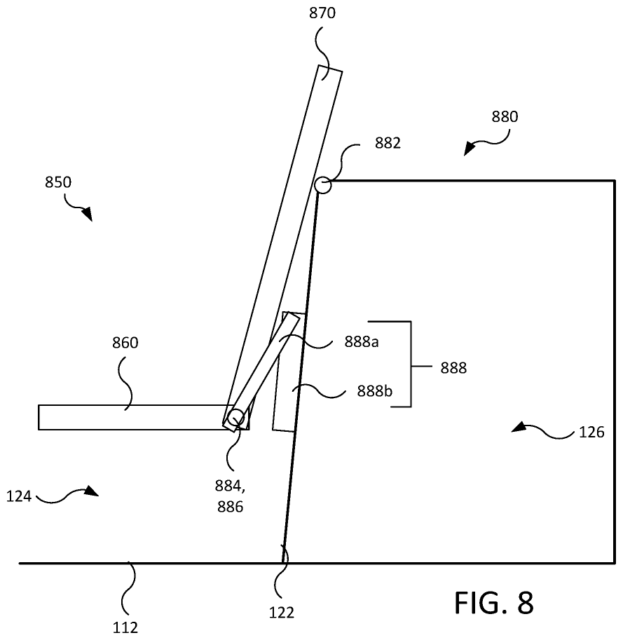

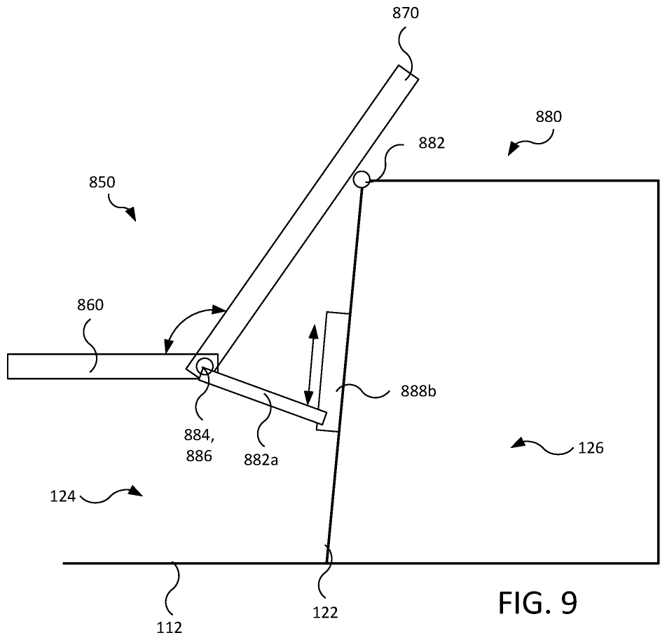

Referring to FIGS. 8-9, a seat 850 is a variation of the seat 150 and generally includes a seat bottom 860, a seat back 870, and a movement and support system 880. Each of the seat bottom 860, the seat back 870, and the movement and support system 880 are as generally described above for the seat bottom 160, the seat back 170, and the movement and support system 180, respectively, and as described in further detail below. The movement and support system 880 generally includes an upper pivot 882, a lower pivot 884, an angle mechanism 886, and a displacement mechanism 888, which are configured as generally described above for the upper pivot 782, the lower pivot 784, the angle mechanism 786, and the displacement mechanism 788, respectively, and as described in further detail below.

The seat 850 is coupled to and supported by either the front side 120 or the rear side 122 (as shown) of the vehicle body 110 by way of the movement and support system 880.

The upper pivot 882 pivotably couples the seat back 870 to the vehicle body 110, such as the rear side 122 thereof (as shown) or alternatively the front side 120. The upper pivot 882 is coupled to seat back 870 at a fixed location thereon. The upper pivot 882 is pivotably coupled to the seat back 870 at a fixed location thereon. The upper pivot 882 is configured for the seat back 870 to pivot relative to the vehicle body 110 about a substantially horizontal axis (e.g., within 15, 10, 5 degrees or less) that extends substantially in a cross-car direction (e.g., perpendicular to the forward direction, such as within 15, 10, 5 degrees or less thereof). The upper pivot 882 is also configured support the seat back 870 relative to the vehicle body 110. The upper pivot 882 may be formed by one or more hinges or other pivot device (e.g., linkage, sliding joint, ball joint). The upper pivot 882 may instead be formed by an articulating joint in which case the seat back translates relative to the vehicle body 110.

The lower pivot 884 pivotably couples the seat bottom 860 to the seat back 870. The lower pivot 884 is coupled to the seat bottom 860 at a fixed location thereon, such as at an exterior side thereof (e.g., the exterior side 160e described previously). The lower pivot 884 is coupled to the seat back 870 at a fixed location thereon, such as at a lower end thereof. The lower pivot 884 is configured for the seat back 870 to pivot relative to the seat bottom 860 about a substantially horizontal axis (e.g., within 15, 10, 5 degrees or less) that extends substantially in the cross-car direction (e.g., perpendicular to the forward direction; within 15, 10, 5 degrees or less thereof). The lower pivot 884 may be formed by one or more hinges or other pivot devices (e.g., linkage, sliding joint, ball joint), such as on left and right sides of the seat 850. The pivot axis of the lower pivot 884 may extend through one of the seat bottom 860 or the seat back 870 and be spaced apart from the other thereof.

The angle mechanism 886 is configured to control the angle between the seat bottom 860 and the seat back 870. In the example shown, the angle mechanism 886 transfers force (e.g., torque) between the seat bottom 860 and the seat back 870. For example, the angle mechanism 886 may be configured with sufficient strength, so as to support the weight of a passenger seat on the seat bottom 860 by transferring torque from the seat bottom 860 to the seat back 870. The angle mechanism 886 is depicted schematically and may be any suitable mechanism suitable for selectively transferring the torque from the seat bottom 860 to the seat back 870 to maintain the seat back 870 in each of the first back position and the second back position. The angle mechanism 886 may, for example, be a locking gear system (e.g., gears fixed to each of the seat bottom 860 and the seat back 870 that are selectively engaged with each other to transfer torque therebetween, such as a conventional recline mechanism), a clutch system, or a motor system (e.g., having an electric motor and gears rotated by the electric motor and coupled to each of the seat bottom 860 and the seat back 870). The angle mechanism 886 may be electrically operated (e.g., by the control system 518) or be manually operated. As is illustrated schematically, the angle mechanism 886 may be integrated with the lower pivot 884 (e.g., provided as a single mechanism).

The displacement mechanism 888 generally includes a linkage 888a and a linear actuator 888b. The linkage 888a is a substantially rigid, elongated member (e.g., a rod). A first end of the linkage 888a is pivotably coupled to the seat bottom 860 at an exterior side thereof (e.g., the exterior side 160e, as described above). A second end of the linkage 888a is pivotably coupled to the linear actuator 888b. The linear actuator 888b is coupled one of the upright structures of the vehicle body 110 (e.g., the front side 120 or the rear side 122, as shown) behind the seat back 870. The linear actuator 888b is configured to selectively move the second end of the linkage along the upright structure of the vehicle body 110, so as to move and selectively maintain the seat bottom 860 between the first bottom configuration (e.g., in the upright seat configuration) and the second bottom configuration (e.g., in the reclined seat configuration). For example, the linear actuator 888b may be selectively operated to move the second end of the linkage 888a downward generally along the rear side 122, which in turn causes the linkage 888a to pivot between a generally upright orientation to a generally horizontal orientation, so as to push the seat bottom 860 away from the upright structure (e.g., the rear side 122). Note that because the upper pivot 882 is fixedly coupled to the seat back 870 and vehicle body 110 and the lower pivot 884 is fixedly coupled to the seat back 870 and the seat bottom 860, the lower pivot 884 and thereby the seat bottom 860 pivot about the upper pivot 882, thereby causing the seat to additionally displace upward away from the floor 112.

The linear actuator 888b may be any suitable actuator, such a ball screw actuator or lead screw actuator, which are operated by an electric motor. The linear actuator 888b and the angle mechanism 886 may be configured to operate simultaneously, such that the angle between the seat bottom 860 and the seat back 870 changes as the seat bottom 860 is displaced away from the upright structure of the vehicle body 110.

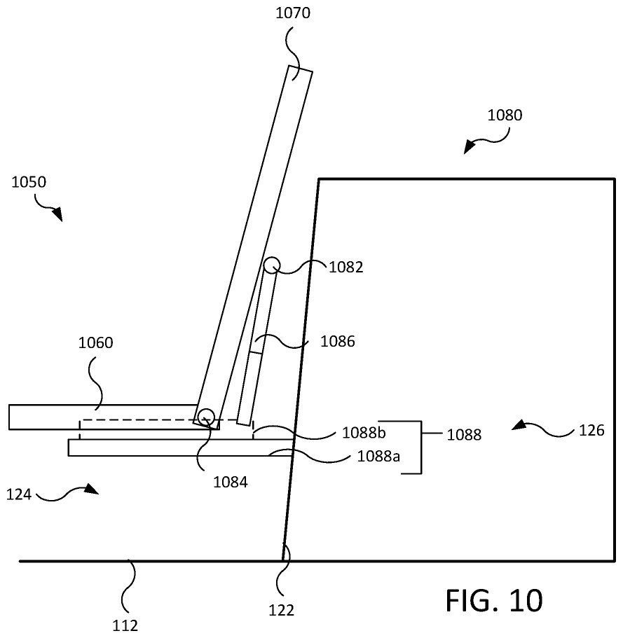

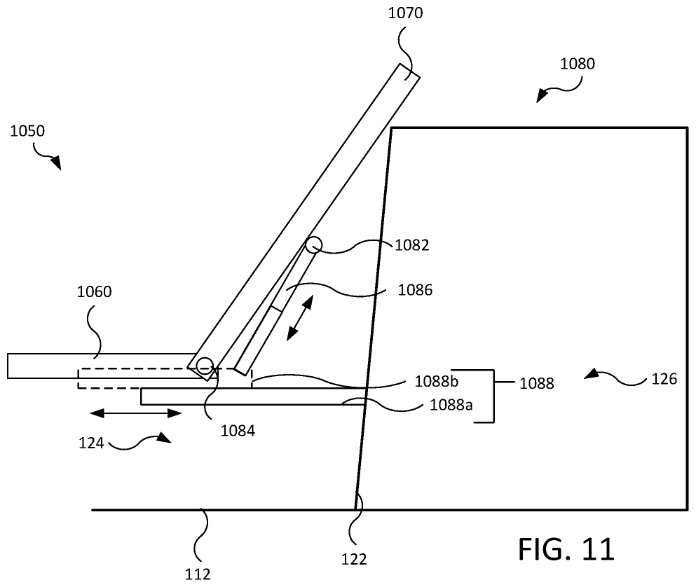

Referring to FIGS. 10-11, a seat 1050 is a variation of the seat 150 and generally includes a seat bottom 1060, a seat back 1070, and a movement and support system 1080. Each of the seat bottom 1060, the seat back 1070, and the movement and support system 1080 are as generally described above for the seat bottom 160, the seat back 170, and the movement and support system 180, respectively, and as described in further detail below. The movement and support system 1080 generally includes an upper pivot 1082, a lower pivot 1084, an angle mechanism 1086, and a displacement mechanism 1088, which are configured as generally described above for the upper pivot 782, the lower pivot 784, the angle mechanism 786, and the displacement mechanism 788, respectively, and as described in further detail below.

The seat 1050 is coupled to and supported by an upright structure of the vehicle body 110, such as the front side 120 or the rear side 122 (as shown) of the vehicle body 110 by way of the movement and support system 1080.

The upper pivot 1082 pivotably couples the seat back 1070 to the angle mechanism 1086 at a fixed location on the seat back 1070, as discussed in further detail below.

The lower pivot 1084 pivotably couples the seat bottom 1060 to the seat back 1070. The lower pivot 1084 is coupled to the seat bottom 1060 at a fixed location thereon, such as at an exterior side thereof (e.g., the exterior side 160e described previously). The lower pivot is coupled to the seat back 1070 at a fixed location thereon, such as at a lower end thereof. The lower pivot 1084 is configured for the seat back 1070 to pivot relative to the seat bottom 1060 about a substantially horizontal axis (e.g., within 15, 10, 5 degrees or less) that extends substantially in the cross-car direction (e.g., perpendicular to the forward direction; within 15, 10, 5 degrees or less thereof). The lower pivot 1084 may be formed by one or more hinges or other pivot devices (e.g., linkage, sliding joint, ball joint), such as on left and right sides of the seat 1050. The pivot axis of the lower pivot 1084 may extend through one of the seat bottom 1060 or the seat back 1070 and be spaced apart from the other thereof.

The angle mechanism 1086 is configured to control the angle between the seat bottom 1060 and the seat back 1070, as discussed in further detail below.

The displacement mechanism 1088 is configured to control displacement between the seat bottom 1060 and the upright structure of the vehicle body 110. As shown, the displacement mechanism 1088 generally includes a track 1088a and a carriage 1088b that slides or otherwise translates along the track 1088a. The track 1088a is fixedly coupled to the upright structure of the vehicle body 110 (e.g., the rear side 122, as shown, or the front side 120, the left side 116, and/or the right side 118). The track 1088a is of sufficient strength to support the seat 1050 and any passengers thereon during use above the floor 112. The carriage 1088b is fixedly coupled to the seat bottom 1060 and is slidable along the track 1088a in a fore-aft direction, for example, using rollers, bearings, and/or bushings. The displacement mechanism 1088 is further configured to selectively maintain the carriage 1088b in stationary positions on the track 1088a using any suitable device, such as a ratcheting device. The displacement mechanism 1088 may further include an actuator (not shown) that moves the carriage 1088b along the track 1088a, such as a ball screw actuator, lead screw, or rack and pinion operated by an electric motor.

Referring again to the upper pivot 1082 and the angle mechanism 1086, the angle mechanism is configured as an extendable linkage (e.g., a cylinder and piston, ball screw, or lead screw) that extends between and is pivotably coupled to the upper pivot 1082 and the carriage 1088b. As the length of the extendable linkage of the angle mechanism 1086 is selectively changed and maintained, the angle between the seat back 1070 and the carriage 1088b and, thereby, the seat bottom 1060 changes and is maintained (e.g., in the first back position and the second back position). For example, as shown, changing from an extended configuration in FIG. 10 to a retracted configuration in FIG. 11, the extendable linkage shortens, such that the seat back 1070 reclines. The angle mechanism 1086 may be manually operated or may include an actuator, such as an electric motor that extends and retracts the extendable linkage (e.g., operates the ball screw or lead screw).

The displacement mechanism 1088 and the angle mechanism 1086 may be configured to operate simultaneously, such that the angle between the seat bottom 1060 and the seat back 1070 changes as the seat bottom 1060 is displaced away from the upright structure of the vehicle body 110. For example, the actuators of the displacement mechanism and the angle mechanism 1086 may be operated simultaneously.

What is claimed is:

1. A passenger vehicle comprising:
a vehicle body that defines a passenger compartment, the vehicle body having a floor; and
a seat having a seat bottom and a seat back that are reconfigurable between an upright configuration and a reclined configuration,
wherein the seat is positioned in the passenger compartment with the seat bottom spaced above the floor to define an underseat volume therebetween,
wherein the seat is coupled to and supported by the vehicle body independent of the floor,
wherein in the reclined configuration relative to the upright configuration, the seat bottom is positioned toward a central portion of the passenger compartment and the seat back is pivoted away from the central portion, and
wherein the underseat volume is accessible from the central portion of the passenger compartment.

2. The passenger vehicle according to claim 1, wherein:
the vehicle body has a left side, a right side, a front side, and a rear side that are coupled to each other and to the floor,
all force transferred from the seat to the floor is transferred thereto through one or more of the left side, the right side, the front side, or the rear side of the vehicle body,
the underseat volume extends unobstructed vertically between the floor and the seat bottom,
the underseat volume extends unobstructed vertically between the floor and the seat bottom across an entire width of the seat bottom,
the seat is configured to move between the upright configuration and the reclined configuration by movement the seat bottom to move toward the central portion of the passenger compartment simultaneous with pivotal movement of the seat back away from the central portion, and
the floor includes any portion of the vehicle body that both defines the passenger compartment and is positioned vertically below the seat bottom.

3. The passenger vehicle according to claim 1, wherein:
the vehicle body has a left side, a right side, a front side, and a rear side that are coupled to each other and to the floor, and
all force transferred from the seat to the floor is transferred thereto through one or more of the left side, the right side, the front side, or the rear side of the vehicle body.

4. The passenger vehicle according to claim 3, wherein the seat is coupled to the rear side independent of the floor such that the force transferred from the seat to the floor is transferred through the rear side.

5. The passenger vehicle according to claim 1, wherein the underseat volume extends unobstructed vertically between the floor and the seat bottom.

6. The passenger vehicle according to claim 5, wherein the underseat volume has a height of at least 20 centimeters extending unobstructed from the floor to the seat bottom at a midpoint between an interior side and an exterior side of the seat bottom.

7. The passenger vehicle according to claim 6, wherein the underseat volume extends unobstructed vertically between the floor and the seat bottom across an entire width of the seat bottom.

8. The passenger vehicle according to claim 6, wherein the seat bottom includes a displacement mechanism by which the seat bottom is moved between the upright configuration and the reclined configuration and by which the seat is coupled to and supported by the vehicle body, the height of the underseat volume extending unobstructed from the floor to the displacement mechanism.

9. The passenger vehicle according to claim 5, wherein:
the vehicle body has a left side, a right side, a front side, and a rear side that are coupled to each other and to the floor, and
the underseat volume extends unobstructed between the left side and the right side of the vehicle body.

10. The passenger vehicle according to claim 9, further comprising another seat positioned laterally adjacent to the seat and further defining the underseat volume.

11. The passenger vehicle according to claim 1, wherein the seat is configured to move between the upright configuration and the reclined configuration by movement of the seat bottom toward the central portion of the passenger compartment simultaneous with pivotal movement of the seat back away from the central portion.

12. The passenger vehicle according to claim 1, wherein the floor includes any portion of the vehicle body that both defines the passenger compartment and is positioned vertically below the seat bottom.

13. The passenger vehicle according to claim 12, wherein:
the vehicle body has a left side, a right side, a front side, and a rear side that are coupled to each other and to the floor, and
one of more of the left side, the right side, the front side, or the rear side are upright structures that extend upward from the floor.

14. The passenger vehicle according to claim 1, wherein:
the vehicle body has a left side, a right side, a front side, and a rear side that are coupled to each other and to the floor, and
the seat is coupled to and supported by one of the front side or the rear side that separates the passenger compartment from one or more of a storage compartment accessible from outside the passenger compartment or a vehicle system compartment that contains one or more of a battery, a motor, a gearbox, or a controller of a drive system of the passenger vehicle.

15. The passenger vehicle according to claim 1, wherein the seat is coupled to and supported by an upright structure of the vehicle body that extends to a position adjacent the seat that is between the seat bottom and an upper end of the seat back.

16. A seat for a passenger vehicle comprising:
a seat bottom moveable between a first bottom configuration and a second bottom configuration in which the seat bottom is positioned forward relative to the first bottom configuration;
a seat back moveable between a first back position and a second back position in which the seat back is titled rearward relative to the first back position;
a bottom pivot by which the seat back is pivotable relative to the seat bottom; and
a movement and support system configured to couple the seat to an upright structure of the passenger vehicle to be supported thereby, to selectively move the seat bottom between the first bottom configuration and the second bottom configuration, and to move the seat back between the first back position and the second back position.

17. The seat according to claim 16, wherein the movement and support system comprises:
an angle mechanism that selectively maintains the seat back in the first back position and the second back position; and
a displacement mechanism that selectively maintains the seat bottom in the first bottom configuration and the second bottom configuration, the displacement mechanism being couplable to an upright structure of the passenger vehicle to support the seat bottom above a floor of the passenger vehicle.

18. The seat according to claim 17, wherein:
the movement and support system further comprises an upper pivot coupled to a fixed position on the seat back and configured to pivotably couple to a fixed position on the upright structure of the passenger vehicle,
the angle mechanism selectively transfers torque between the seat bottom and the seat back to selectively maintain the seat back in the first back position and the second back position, and
the displacement mechanism includes a linkage and a linear actuator, the linkage being pivotably coupled at one end to the seat bottom and another end to the linear actuator, and the linear actuator being configured to move the other end of the linkage along the upright structure to move the seat bottom between the first bottom configuration and the second bottom configuration.

19. The seat according to claim 17, wherein:
the displacement mechanism includes a track that is couplable to the upright structure and a carriage coupled to the seat bottom and slidable along the track, and
the angle mechanism includes a linkage that is pivotably coupled to the seat back at a fixed location thereon and to the carriage at another fixed location thereon, the linkage being selectively extendable to selectively maintain the seat back in the first back position and the second back position.

20. A seat for a passenger vehicle comprising:
a seat bottom;
a seat back;
a bottom pivot by which the seat back is pivotably coupled to the seat bottom;
an upper pivot by which the seat back is pivotably couplable to an upright structure of a vehicle body, the upper pivot being at a fixed position on the seat back;
an angle mechanism that selectively transfers force between the seat bottom and the seat back to selectively maintain the seat back in each of a first back position and a second back position having a greater angle between the seat back and the seat bottom than in the first back position; and
a displacement mechanism coupled to an upright structure of the vehicle and configured to selectively maintain the seat bottom in each of a first bottom position and a second bottom position in which the seat bottom is further from the upright structure than in the first bottom position.

21. The seat according to claim 20, wherein the displacement mechanism comprises a linkage and a linear actuator, wherein the linkage is a rigid elongated structure pivotably coupled at a first end thereof to the seat bottom and at a second end thereof to the linear actuator, and the linear actuator is configured to couple to the upright structure of the vehicle body and selectively move the second end of the linkage along the upright structure to selectively maintain the seat bottom in each of a first bottom position and a second bottom position in which the seat bottom is further from the upright structure than in the first bottom position.

22. The seat according to claim 20, wherein the displacement mechanism comprises a track and a carriage, wherein the track is fixedly couplable to the upright structure of a vehicle body to support the seat bottom above a floor of the vehicle body, and the carriage is fixedly coupled to the seat bottom and is selectively slidable along the track to selectively maintain the seat bottom in a first bottom position and a second bottom position in which the seat bottom is displaced further away from the upright structure than in the first bottom position.

23. The seat according to claim 20, wherein the angle mechanism comprises an extendable linkage that extends between and is pivotably coupled to the upper pivot at a fixed position on the seat back and the carriage, wherein the extendable linkage is selectively extendable to selectively maintain the seat bottom and the seat back in each of the first back position and the second back position.
